(19) United States
(12) Patent Application Publication
(10) Pub. No.: US 2006/0276288 A1
(43) Pub. Date: Dec. 7, 2006

(54) Hybrid drive unit

(75) Inventors: Makoto Iwanaka, Nisio (JP); Shigeki Takami, Anjo (JP)

Correspondence Address: OLIFF & BERRIDGE, PLC, P.O. BOX 19928, ALEXANDRIA, VA, 22320, US

(73) Assignee: AISIN AW CO., LTD., Anjo-shi (JP)

(21) Appl. No.: 11/444,319

(22) Filed: Jun. 1, 2006

(30) Foreign Application Priority Data
Jun. 7, 2005 (JP) 2005-166945
Jun. 7, 2005 (JP) 2005-166946

(51) Int. Cl. F16H 3/72; F16H 3/44

(52) U.S. Cl. 475/5; 475/323

(57) ABSTRACT

A hybrid drive unit including two electric motors is provided which is capable of providing continuously variable transmission, and prevents deterioration in energy recovery efficiency, without causing deterioration in power transmission efficiency in a high-vehicle speed and low-driving force range. In order to achieve shifting through a planetary gear unit and three friction engagement elements, first and third power transmission states are formed such that an input shaft is connected to a first rotating element of the planetary gear unit, a first electric motor is connected to a second rotating element, and an output shaft and a second electric motor are connected to a third rotating element, and a second power transmission state is formed such that the input shaft, the output shaft, the first electric motor and the second electric motor are independently connected to four rotating elements of the planetary gear unit.

### INCORPORATION BY REFERENCE

Priority is claimed from Japanese Patent Applications No. 2005-166945 and 2005-166946, both filed on Jun. 7, 2005, the disclosures including the specification, claims, drawings and Abstract, of which are incorporated herein by reference in their entireties.

### BACKGROUND

The disclosure relates to a hybrid drive unit, and more particularly relates to a hybrid drive unit including an input shaft for receiving driving force from an engine, first and second electric motors, a planetary gear unit, and an output shaft for outputting driving force to wheels.

A hybrid drive unit with the above configuration is disclosed in Japanese Patent Application Publication No. JP-A-2005-61498. The hybrid drive unit disclosed in the identified publication is configured to include first and second electric motors (motor generators) 2, 3, a power transfer mechanism 40 composed of a planetary gear mechanism, and a transmission 41 composed of two planetary gear mechanisms, as shown in FIG. 1 of the publication, for example.

The hybrid drive unit described in the publication achieves a plurality of shift speeds by changing the combination of the engagement of brakes B1, B2, a one-way clutch F1, and a clutch C1, which are friction engagement elements.

The above hybrid drive unit adopts a stepped speed change mechanism at a downstream side of the transmission of a so-called three-element structure including first and second electric motors 2, 3 and a single planetary gear mechanism. This configuration is, therefore, effective for reducing the motor size, however, it is accompanied by shock when shifting gears due to operation of the stepped speed change at the downstream side.

In the present specification, hereinafter, an “electric motor” is used as the generic term for a “motor”, a “motor generator”, and a “generator”, and denoted by “MG” unless otherwise stated. Regarding a planetary gear mechanism including three rotating elements, i.e., a sun gear, a carrier and a ring gear, each device that is composed of a single planetary gear mechanism or a combination of a plurality of planetary gear mechanisms, and has a function of driving power distribution, deceleration or the like is referred to as a planetary gear device. Further, a unit that is composed of a single planetary gear device or a combination of a plurality of planetary gear devices, and includes a rotating element relating to power input, a rotating element relating to power output, and a rotating element relating to shifting is referred to as a planetary gear unit.

Japanese Patent No. 3220115, U.S. Pat. No. 5,931,757 is the U.S. equivalent, proposes a structure that reduces the above-mentioned shock when shifting gears. A hybrid drive unit proposed in this patent is also configured to include an input shaft connected to an engine, first and second electric motors, and a planetary gear unit.

The hybrid drive unit is configured to include a power transmission mechanism shown in FIG. 1 of Japanese Patent No. 3220115 (FIG. 8 of the present application is a copy of FIG. 1). The unit has modes of operation, that is, a first mode on a low-speed side and a second mode on a high-speed side.

The unit includes an input shaft 12 for receiving driving force from an engine 14, an output shaft 64 for outputting driving force to wheels. First and second electric motors 56, 72 are operationally connected to an energy storing device 76, and exchange power with the energy storing device 76. A control device 74 is provided to control power exchange between the energy storing device 76 and the first and second electric motors 56, 72. The control device 74 further controls power exchange between the first and second electric motors 56, 72.

The control device 74 controls the power exchange between the first and second electric motors 56, 72 such that the first electric motor 56 mainly maintains the rotational speed of the engine 14 at a predetermined rotational speed, and the second electric motor 72 assists driving force that is insufficient when using the engine 14 alone.

As shown in FIG. 1 of Japanese Patent No. 3220115 (FIG. 8 herein), the hybrid drive unit includes three planetary gear mechanisms 24, 26, 28 and two friction engagement elements 62, 70.

FIG. 9 of the present application shows the relationship between the vehicle speed and the speeds of the engine and respective electric motors, which is the same as the one shown in FIG. 5 of Japanese Patent No. 3220115. Further'shown on the lower side of FIG. 9 are the switching state between the first and second modes, and the operation state of each electric motor, that is, whether it functions as a motor or as a generator (described as “power generation” in the figure).

FIG. 10 of the this application shows the speed (described as input speed), electric motor torque, and electric motor output of the hybrid drive unit.

The relationship between FIGS. 9 and 10 is such that the speed shown at the top of FIG. 10 corresponds to the speed shown in FIG. 9, and the vehicle speed range in FIG. 10 is wider than that in FIG. 9.

Returning to FIG. 9, the hybrid drive unit switches modes between the first mode adopted on the low-speed side and the second mode adopted on the high-speed side, by switching friction engagement elements. The power transmission state in the second mode is maintained as it is even if the vehicle speed exceeds the range shown in FIG. 9 and further increases.

The power transmission state in the first mode is called a “three-element structure”, and the power transmission state in the second mode is called a “four-element structure”.

With reference to FIG. 11, the “three-element structure” and the “four-element structure” will be explained.

In the figure, respective rotating elements that constitute a planetary gear unit are denoted by o, connecting states of the respective rotating elements are denoted by arms (horizontal and vertical bars). A rotating element connected to an engine is denoted by (E), and a rotating element connected to the output shaft is denoted by (OUT). Further, a rotating element connected to a first electric motor MG1 is denoted by (MG1), and a rotating element connected to a second electric motor MG2 is denoted by (MG2). In this application, the term “connection” includes both of the following: a direct connection in which a rotating element and an element connected to the rotating element rotate at the same speed; and a connection in which the rotational speeds of a rotating element and an element connected to the rotating element assume a fixed ratio.

Three-Element Structure

As shown in FIG. 11A, in the three-element structure, driving force is input from the engine E to a particular rotating element (a first rotating element) of a planetary gear device Pa. Responding to this input, a rotating element (a second rotating element) connected to the first electric motor MG1 mainly receives reaction force. At the same time, the remaining rotating element (a third rotating element) is connected to the output OUT, and the second electric motor MG2 is connected to the remaining rotating element (the third rotating element).

More specifically, as shown in the velocity diagram, in the planetary gear unit, the first rotating element that receives driving force from the engine is arranged between the second and third rotating elements that are respectively connected to the first and second electric motors MG1, MG2. Then, the driving force of the third rotating element connected to the second electric motor MG2 is output.

In the case of the foregoing FIG. 8, in the first mode, the carrier works as an idler, and the planetary gear mechanisms 24, 26 work together as a planetary gear unit that defines the three-element structure. Further, the electric motor 56 works as the first electric motor MG1, and the electric motor 72 works as the second electric motor MG2. The planetary gear mechanism 28 only works as a decelerating device.

Four-Element Structure

As shown in FIG. 11B, in the four-element structure, in a mechanism composed of first and second planetary gear devices Pa, Pb, driving force from the engine E is input to a particular rotating element (an input rotating element) of the first planetary gear device Pa. The remaining two rotating elements of the first planetary gear device Pa become rotating elements connected to the output OUT and the second electric motor MG2. In this case, the rotating element connected to the output OUT is an output rotating element.

On the other hand, different rotating elements of the second planetary gear device Pb are connected to the rotating elements of the foregoing first planetary gear device Pa that are connected to the engine E and the output OUT. The remaining rotating element is connected to the first electric motor MG1.

In other words, the power transmission state of the four-element structure is accomplished by providing the second planetary gear device Pb, in addition to the first planetary gear device Pa. The first planetary gear device Pa includes the input rotating element connected to the input shaft, the output rotating element connected to the output shaft, and the rotating element connected to the second electric motor. The second planetary gear device Pb includes the rotating element connected to the input rotating element of the first planetary gear device Pa, the rotating element connected to the output rotating element of the first planetary gear device Pa, and the rotating element connected to the first electric motor.

Accordingly, in the case of a planetary gear unit composed of the paired planetary gear devices Pa, Pb, this planetary gear unit includes four rotating elements as rotating elements arranged in the velocity diagram. If the rotating states of two rotating elements out of the four rotating elements are determined, the rotating states of the remaining rotating elements are determined, namely, the planetary gear unit has two-degrees-of-freedom. The planetary gear unit is configured such that respective rotating elements thereof are separately connected to the input shaft from the engine E, the output shaft to the wheels, and two electric motors MG1, MG2.

In the case of the foregoing FIG. 8, in the second mode, the planetary gear mechanisms 24, 26, 28 are combined to form the four-element structure. The electric motor 56 works as the first electric motor MG1, and the electric motor 72 works as the second electric motor MG2.

As described above, the invention described in Japanese Patent No. 3220115 achieves power transmission of the three-element structure in the first mode on the low-speed side, and performs power transmission of the four-element structure in the second mode on the higher speed side.

Returning to FIG. 10, as described earlier, the graphs show the speed (at the top), the electric motor torque (in the middle), and the electric motor output (at the bottom) of the hybrid drive unit according to the invention described in Japanese Patent No. 3220115.

Marks in the box in each graph show the line classification. In these graphs, “3Lo” shows the above-described “power transmission of the three-element structure on the low-speed side”, and “4Hi” shows the above-described “power transmission of the four-element structure on the high-speed side”. Accordingly, “3Lo” and “4Hi” correspond to the above-described first mode and the second mode, respectively.

On the other hand, in the top graph, “Ne”, “Nmg1”, “Nmg2”, and “Nout” described to the right of the above-mentioned marks show the speeds (rotational speeds) of an input shaft I, the first and second electric motors MG1, MG2, and an output shaft O, respectively. “Tmg1”, and Tmg2” in the middle graph show the torques of the first and second electric motors MG1, MG2, respectively. “Pmg1” and “Pmg2” in the bottom graph show the outputs of the first and second electric motors MG1, MG2, respectively. When the output is positive, the electric motor works as a motor, and when the output is negative, the electric motor works as a generator.

As shown in FIG. 9, which corresponds to FIG. 5 of Japanese Patent No. 3220115, the switching from the first mode to the second mode is performed in accordance with the switching of the friction engagement elements, at a vehicle speed indicated by the vertical line denoted by the reference numeral 94 in FIG. 9. Also in FIG. 10 of the present application, the switching from the first mode to the second mode is performed at the vertical line.

In the related art, the first mode on the low-speed side and the second mode on the high-speed side are provided as modes, and in the second mode, the power transmission state of the four-element structure is maintained. This power transmission state is maintained even in a higher vehicle speed range. Accordingly, in the vehicle speed range on the higher speed side (the region close to the right end of FIG. 9), it can be found that while the first electric motor MG1 works as a motor, the second electric motor MG2 works as a generator, and its output has a relatively large value.

In the above-described hybrid drive unit of the four-element structure, during regeneration, one electric motor is in a regenerating state (i.e., works as a generator), and the other electric motor is in a powering state (i.e., works as a motor).

However, in the case of the four-element structure, power that is equal to, or greater than, the deceleration energy is electrically converted, so that the energy recovery efficiency deteriorates.

This problem will be hereinafter explained using the relationship with the above-described power transmission state.

In the case of the three-element structure, as shown in FIG. 11A, the first electric motor MG1 and the rotating element connected to the second electric motor MG2 are located on opposite sides in the velocity diagram such that the rotating element connected to the engine is interposed therebetween.

In a state where the regenerative braking is applied, the engine speed is reduced to stop the engine, and the speed of the first electric motor MG1 is also reduced.

In the case of the three-element structure, the rotating element OUT for output, and the rotating element connected to the second electric motor MG2 are the same rotating element. Accordingly, inertia force still remaining after the regenerative braking is applied is directed to the output OUT so that it can be directly received by the second electric motor MG2.

On the other hand, in the case of the four-element structure, as shown in FIG. 11B, the first and second electric motors MG1, MG2 are located on opposite sides in the velocity diagram showing the four elements as a whole. Inside thereof, the rotating element for receiving the engine output and the rotating element connected to the output side are arranged.

When the regenerative braking is applied, the engine speed is reduced to stop the engine, and the speed of the first electric motor MG1 is also reduced. In the case of the four-element structure, the rotating element OUT, related to output, and the rotating element connected to the second electric motor MG2 are different rotating elements. Accordingly, the rotating element connected to the output OUT works to maintain the rotation at the present condition due to the remaining inertia force in accordance with the vehicle running. In this condition, both of the first and second electric motors MG1, MG2 need to work to reduce the engine speed. As a result, in terms of behavior during regenerative braking, the three-element structure has an advantage over the four-element structure.

Furthermore, in a high vehicle speed and low driving force range (or a negative hybrid range), the electric conversion rate is increased, and consequently transmission efficiency deteriorates. This condition will also be described in comparison between the three-element structure and the four-element structure.

In the case of the three-element structure, as shown in FIG. 11A, the first and second electric motors MG1, MG2 are located on opposite sides in the velocity diagram, with the engine being interposed therebetween.

On the other hand, in the case of the four-element structure, as shown in FIG. 11B, the first and second electric motors MG1, MG2 are located on opposite sides in the velocity diagram showing the four elements as a whole. Inside thereof, the rotating element for receiving the output of the engine E and the rotating element connected to the output OUT are arranged.

Considering transmission efficiency for these structures, a lever having a fulcrum as an input position of the driving force from the engine may be given as an example. At high vehicle speed, the speeds of the second electric motor MG2 and the output OUT are high. Their operational positions from the fulcrum are the same in the case of the three-element structure. Accordingly, it is sufficient for the first electric motor MG1 to generate torque corresponding to the moment when the fulcrum is the input position of the driving force from the engine. On the other hand, in the case of the four-element structure, when viewed from the fulcrum, which is the input position of the driving force from the engine, the positions of the output OUT and the second electric motor MG2 are different, and the position of the second electric motor MG2 is away from the fulcrum. Accordingly, the first electric motor MG1 needs to generate a larger torque in the reverse direction compared to the case of the three-element structure.

This condition will be hereinafter described briefly with reference to FIGS. 3 and 10, which show the condition in detail. The bottom graphs in FIGS. 3 and 10 show the electric motor output. In these graphs, the horizontal axis shows the vehicle speed, and the vertical axis shows the electric motor output. Accordingly, the high-speed range is the region close to the right end of the graph.

Incidentally, FIG. 3 shows the output when the power transmission state of the three-element structure according to the instant disclosure is adopted in this range, while FIG. 10 shows the output when the power transmission state of the four-element structure of the related art is adopted in this range. When comparing the results of FIGS. 3 and 10, the change rate of the outputs of the first and second electric motors (an increase rate of the output difference between the two electric motors) in accordance with an increase in vehicle speed is larger in FIG. 10, which means that the four-element structure is disadvantageous.

### SUMMARY

The invention is made in light of the foregoing problems, and it is an object of the invention to provide a hybrid drive unit including a planetary gear unit and two electric motors between an input shaft and an output shaft. The hybrid drive unit can achieve a continuously variable transmission without stepped speed change when changing gears by engaging or disengaging a plurality of friction engagement elements, prevents deterioration in energy recovery efficiency during regeneration, and does not cause deterioration in power transmission efficiency at a high vehicle speed and low driving force range (or a negative hybrid range).

In order to achieve the above-described object, the hybrid drive unit including an input shaft for receiving driving force from an engine; an output shaft for outputting the driving force to a wheel; a first electric motor and a second electric motor; a planetary gear unit; a first friction engagement element that forms a first power transmission state between the input shaft and the output shaft; a second friction engagement element that forms a second power transmission state between the input shaft and the output shaft; and a third friction engagement element that forms a third power transmission state between the input shaft and the output shaft, has the following characteristic configuration. In the first power transmission state, the input shaft is connected to a first rotating element of the planetary gear unit, the first electric motor is connected to a second rotating element of the planetary gear unit, and the output shaft and the second electric motor are connected to a third rotating element of the planetary gear unit. In the second power transmission state, the input shaft, the output shaft, the first electric motor, and the second electric motor are independently connected to four rotating elements of the planetary gear unit. In the third power transmission state, the input shaft is connected to the first rotating element of the planetary gear unit, the first electric motor is connected to the second rotating element of the planetary gear unit, and the output shaft and the second electric motor are connected to the third rotating element of the planetary gear unit, and a speed reduction ratio is smaller than that in the first power transmission state.

Note that the speed reduction ratio is determined as (input rotational speed)/(output rotational speed) in the hybrid drive unit. More specifically, the speed reduction ratio is determined as (rotational speed of an input shaft I/(rotational speed of an output shaft O) in an embodiment to be described later.

The hybrid drive unit realizes the first to third power transmission states as its power transmission state, according to engagement/disengagement of friction engagement elements.

The first power transmission state and the third power transmission state are achieved in the following manner. In a state where driving force is transmitted from the input shaft to the output shaft through the planetary gear unit, the input shaft is connected to the first rotating element of the planetary gear unit, the first electric motor is connected to the second rotating element of the planetary gear unit, and the output shaft and the second electric motor are connected to the third rotating element of the planetary gear unit. That is, a power transmission state of the above-described three-element structure is achieved, and their speed reduction ratios are different from each other.

Accordingly, as described earlier, in these power transmission states, the hybrid drive unit does not cause deterioration in energy conversion efficiency during regeneration. Further, it is possible to prevent deterioration in power transmission efficiency due to increased power conversion rate in the high-vehicle speed and low-driving force range.

On the other hand, the second power transmission state is achieved in the following manner. In a state where driving force is transmitted from the input shaft to the output shaft through the planetary gear unit, the input shaft, the output shaft, the first electric motor, and the second electric motor are independently connected to four rotating elements constituting the planetary gear unit. That is, a power transmission state of the above-described four-element structure is achieved.

This power transmission state is disadvantageous to the three-element structure. However, a range of the speed reduction ratio to be covered by the second power transmission state can be set in view of a range of the speed reduction ratio covered by the first and third power transmission states. As a result, energy conversion efficiency can be set within a predetermined allowable range during regeneration.

In the hybrid drive unit according to the invention, three power transmission states are achieved by engagement/disengagement of the first to third friction engagement elements. Two power transmission states are made to be the power transmission state of the three-element structure, and the remaining one is made to be the power transmission state of the four-element structure. Thus, the range of the speed reduction rate (speed range) to be covered by each of the power transmission states can be appropriately selected and set. Accordingly, it is possible to achieve power transmission that does not cause deterioration in energy recovery efficiency and deterioration in power transmission efficiency.

As a result, with a combination of the planetary gear unit and a limited number of friction engagement elements, driving force from the engine is received, and then distributed to the first and second electric motors. While these electric motors are working as a generator or a motor, deterioration in energy recovery efficiency can be prevented during regeneration. Further, it is possible to provide a hybrid drive unit that does not cause a considerable deterioration in power transmission efficiency in the high vehicle speed and low driving force range (or the negative hybrid range).

Note that, in terms of engagement/disengagement of the friction engagement elements, it is preferable that engagement and disengagement of two friction engagement elements in the first to third friction engagement elements are operatively associated with each other.

In this case, of the two friction engagement elements, one is engaged and the other is disengaged. Accordingly, different power transmission states can be realized by the operation of engagement/disengagement of the least number of friction engagement elements. The power transmission state is thereby changed in a stable manner. As a result, the hybrid drive unit with a high reliability can be provided.

Further, it is preferable that, on the condition that two members engaged by the friction engagement elements rotate at the same speed, the power transmission state is switched by switching of an engagement/disengagement state of the two friction engagement elements in the first to third friction engagement elements. With the above configuration, shock is prevented when switching the power transmission state.

The first friction engagement element is a brake that stops, in an engagement state, rotation of a rotating element of a planetary gear device working as a speed reduction device. It is preferable that, in the first power transmission state, only the first friction engagement element is engaged, and rotation of the third rotating element of the planetary gear unit is decelerated by the speed reduction device and then transmitted to the output shaft.

In the first power transmission state, the first electric motor works to receive reaction force against the driving force from the engine, and the driving rotation is transmitted from a rotating element (the third rotating element) connected to a rotor of the second electric motor to the output shaft. Accordingly, in the power transmission, by means of the first friction engagement element, the planetary gear device, working as the speed reduction device, is used for speed reduction, whereby a relatively large speed reduction rate can be realized.

The second friction engagement element is a clutch that directly connects, in an engagement state, the output shaft with one rotating element of the planetary gear unit. It is also preferable that, in the second power transmission state, only the second friction engagement element is engaged, and the output shaft is directly connected to the one rotating element in the four rotating elements of the planetary gear unit.

In the second power transmission state, the output shaft is directly connected to one rotating element (an output rotating element) of four rotating elements of the planetary gear unit by engagement of the clutch. Thus, driving rotation that can be obtained in the second power transmission state can be transmitted to the output shaft as it is. Accordingly, with the simplest structure, one power transmission state (the second power transmission state) desired for the invention can be realized.

The third friction engagement element is a clutch that directly connects, in an engagement state, two rotating elements of one planetary gear mechanism. It is preferable that, in the third power transmission state, only the third friction engagement element is engaged to fix the planetary gear mechanism, whereby rotation of the third rotating element of the planetary gear unit is transmitted to the output shaft as it is.

In the third power transmission state, the output shaft is directly connected to the third rotating element by engaging the clutch. Thus, driving rotation that can be obtained in the third power transmission state is transmitted to the output shaft as it is. Accordingly, with the simplest structure, one power transmission state (the third power transmission state) desired for the invention can be realized.

It is preferable that the first electric motor, the second electric motor, and a switching mechanism having the first to third friction engagement elements are coaxially provided; and the first electric motor, the second electric motor, and the switching mechanism are arranged in order from a side of the engine to a side of the output shaft.

According to this configuration, large-size elements are provided from the side of the engine, and the hybrid drive unit as a whole can be configured such that the side of the output shaft connected to the wheels is compact. Thus, the hybrid drive unit is more likely to be adopted in conventionally configured vehicles.

Further, it is preferable that the planetary gear unit includes three planetary gear mechanisms; and in the third power transmission state, one planetary gear mechanism is fixed by engagement of the third friction engagement element, and the output shaft and the third rotating element of the planetary gear unit rotate at the same speed.

With this configuration, the third rotating element and the output shaft rotate at the same speed (i.e., a direct coupling state is realized) in one planetary gear mechanism, and the remaining planetary gear mechanism (that may be one or a combination of two planetary gear mechanisms) distributes the driving force from the engine between the first and second electric motors. Thus, driving rotation that can be obtained by the third rotating element is determined.

Accordingly, in the hybrid drive unit which includes the first and second electric motors and the first to third friction engagement elements, and which realizes the first, the second, and the third power transmission state, a required number of power transmission states can be realized with a combination of a small number of planetary gears.

On the other hand, the configuration of the second power transmission state can be realized by providing a second planetary gear device, in addition to a first planetary gear device, as the planetary gear unit. The first planetary gear device includes an input rotating element connected to the input shaft, an output rotating element connected to the output shaft, and a rotating element connected to the second electric motor. The second planetary gear device includes a rotating element connected to the input rotating element of the first planetary gear device, a rotating element connected to the output rotating element of the first planetary gear device, and a rotating element connected to the first electric motor. Thus, the second power transmission state can be realized by the connection or combination of the paired planetary gear devices.

A hybrid drive unit including an input shaft for receiving driving force from an engine; an output shaft for outputting the driving force to a wheel; a first electric motor and a second electric motor; and a planetary gear unit, has the following characteristic configuration. The hybrid drive unit has three operation modes including a first mode driven by a three-element structure in which the input shaft is connected to a first rotating element of the planetary gear unit, the first electric motor is connected to a second rotating element of the planetary gear unit, and the output shaft and the second electric motor are connected to a third rotating element of the planetary gear unit; a second mode driven by a four-element structure in which the input shaft, the output shaft, the first electric motor, and the second electric motor are independently connected to four rotating elements of the planetary gear unit; and a third mode driven by the three-element structure in which a speed reduction ratio is different from that in the first mode. As the speed reduction ratio becomes small, switching is performed in the order from the first mode, the second mode, to the third mode.

The hybrid drive unit with the above configuration includes the third mode that is on an even higher speed side (or a lower speed reduction ratio side) compared to the first and second modes. In the third mode, the power transmission state of the three-element structure is adopted.

Accordingly, compared to a hybrid drive unit of the related art which transmits driving force in the four-element structure, a hybrid drive unit can be provided which can prevent deterioration in energy recovery efficiency during regeneration, as well as prevent deterioration in power transmission efficiency in the high vehicle speed and low driving force range (or the negative hybrid range).

Further, in the third mode, it is preferable to adopt a configuration in which a rotational speed of the third rotating element obtained by the three-element structure is directly transmitted to the output shaft.

With the above configuration, in the first mode, the driving power output is obtained by the three-element structure; and in the second mode, the driving power output is obtained by the four-element structure. Further, on a higher speed side than the two modes, the driving power output is obtained by a direct-coupling structure of the three-element structure.

Further, as a specific configuration, the following configuration may be adopted. The first electric motor, the second electric motor, and as the planetary gear unit, a planetary gear device working as a split device that distributes the driving force from the engine between the first electric motor and the second electric motor, and a planetary gear device working, in a power transmission state of the three-element structure, as a speed reduction device that reduces driving force output from the third rotating element, are coaxially provided. The first electric motor, the split device, the second electric motor, and the speed reduction device are arranged in order from the side of the engine to the side of the output shaft.

According to this configuration, large-size elements are provided from the side of the engine, and the hybrid drive unit as a whole can be configured such that the side of the output shaft connected to wheels is compact. Thus, the hybrid drive unit is more likely to be adopted in conventionally configured vehicles.

Further, it is preferable that three friction engagement elements and the two planetary gear devices as the planetary gear unit are provided; the driving force from the engine is distributed between the first electric motor and the second electric motor; and an output mechanism for selectively outputting the distributed output to the output shaft is provided in a main body of the drive unit at a position farthest from the engine.

With this configuration, the hybrid drive unit as a whole can be configured such that its output shaft side is compact. Thus, the hybrid drive unit is more likely to be adopted in conventionally configured vehicles.

### BRIEF DESCRIPTION OF THE DRAWINGS

The disclosure will be made with reference to the drawings in which:

FIG. 1 is a diagram showing a power transmission system of a hybrid drive unit according to the disclosure;

FIG. 2 is a velocity diagram of the hybrid drive unit;

FIG. 3 is a view showing the relationship of the speed, torque, and output of the hybrid drive unit;

FIG. 4 is a view showing the driving force in each mode obtained by the hybrid drive unit;

FIG. 5 is a view showing a power transmission system of a second embodiment of the hybrid drive unit according to the disclosure;

FIG. 6 is a view showing a power transmission system of a third embodiment of the hybrid drive unit according to the disclosure;

FIG. 7 is a view showing a power transmission system of a fourth embodiment according to the disclosure;

FIG. 8 is a view showing a power transmission system of a hybrid drive unit of a related art;

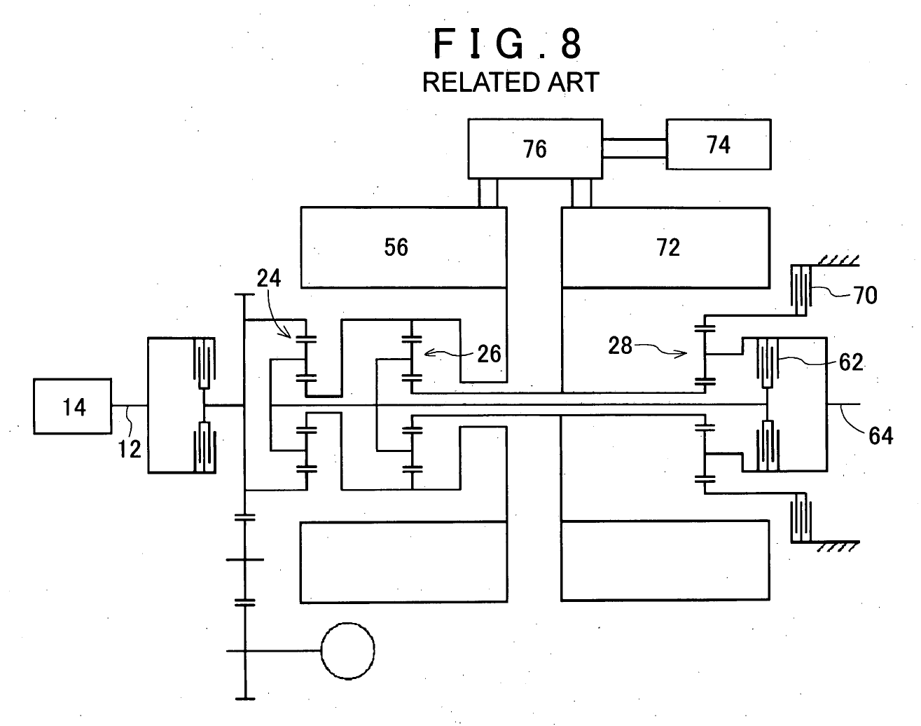

FIG. 9 is a view showing the speeds of electric motors and an engine of the hybrid drive unit of the related art;

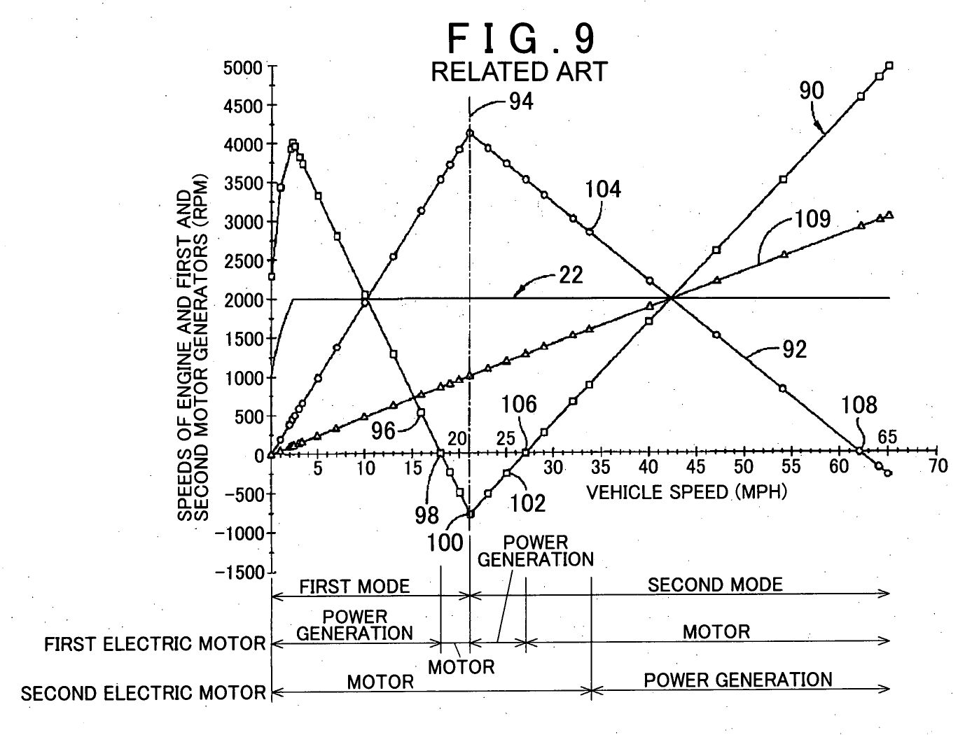

FIG. 10 is a view showing the relationship of the speed, torque, and output of the hybrid drive unit of the related art; and

FIGS. 11A and 11B are explanatory views of a three-element structure and a four-element structure, respectively.

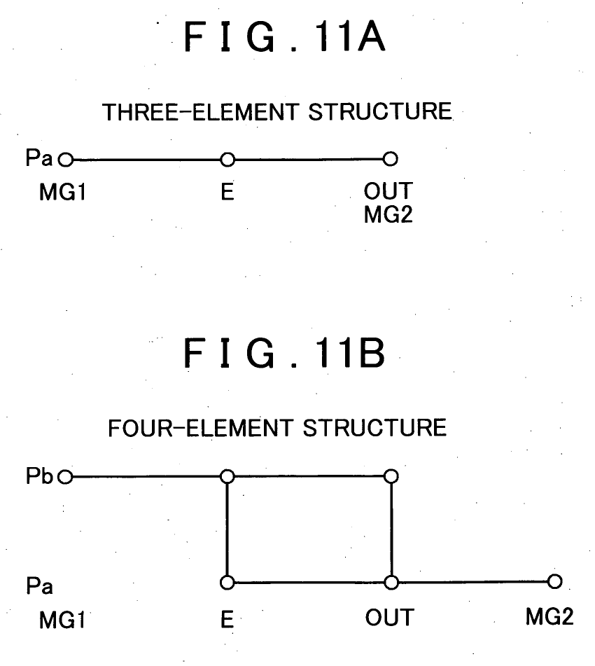

### DETAILED DESCRIPTION OF EMBODIMENTS

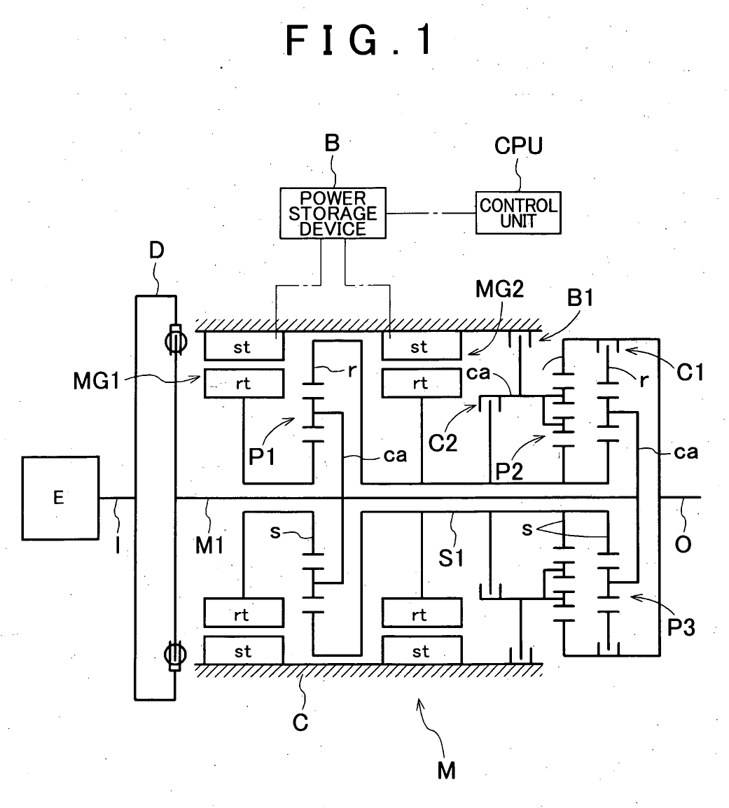

FIG. 1 is a schematic diagram showing a power transmission system of a hybrid drive unit M. The hybrid drive unit M receives, at an input shaft I, driving force from an engine E provided on the left side of the drawing, and outputs the driving force from an output shaft O after shifting.

As shown in FIG. 1, the hybrid drive unit M is provided with two electric motors (first and second electric motors MG1, MG2), and a planetary gear unit. The planetary gear unit includes a planetary gear device for distributing the driving force from the engine, and a speed reduction device having three friction engagement elements (i.e., first and second clutches C1, C2, and a brake B1). The first and second electric motors, the planetary gear device, and the speed reduction device are coaxially arranged.

The first and second electric motors MG1, MG2 are configured to include a stator st provided on a casing C and a rotor rt that is rotatable with respect to the stator st, which are electrically connected to a power storage device B, respectively. In a state where the electric motor MG works as a motor, the hybrid drive unit M operates by receiving the power supply from the power storage device B or the other electric motor MG, which works as a generator. In a state where the electric motor MG works as a generator, power can be stored in the power storage device B, or power is supplied to the other electric motor MG, which works as a motor.

The hybrid drive unit M is provided with a control unit CPU for controlling operation of the drive unit M. The control unit CPU controls the speeds of the first and second electric motors MG1, MG2. The control unit CPU is configured to input information on the operations of an accelerator pedal and a brake pedal, and information on engine speed, as well as information on the rotational speeds of the input shaft I and the output shaft O. Based on the input information, the control unit CPU determines whether to accelerate or decelerate a vehicle according to a predetermined sequence derived from the operation by a driver. At the same time, along with the determination, the control unit CPU monitors the condition of the engine E, and determines the output rotational speed of the hybrid drive unit M required for applying a desired acceleration or deceleration.

In the actual procedure, the control unit CPU issues a control command to adjust the rotational speeds of the first and second electric motors MG1, MG2 to suitable speeds for a target vehicle speed, while referring to the relationship between the rotational speeds of the input shaft and the output shaft. In addition, in the case where engagement or disengagement of the friction engagement elements C1, C2, B1 is required, the control unit CPU issues a control command to the friction engagement elements.

As shown in FIG. 1, the hybrid drive unit M includes an intermediate shaft M1 disposed between the input shaft I and the output shaft O, and a connecting shaft S1 that is supported rotatably with respect to the intermediate shaft M1. A damper D is interposed between the input shaft I and the intermediate shaft M1.

The drive unit M is provided with three planetary gear mechanisms. The planetary gear mechanisms are referred to as first, second and third planetary gear mechanisms P1, P2, P3, in this order from the input shaft I side. As shown in the figure, the first and third planetary gear mechanisms P1, P3 are of a single pinion type, while the second planetary gear mechanism P2 is of a double pinion type.

The intermediate shaft M1 is configured to rotate integrally with carrier shafts ca of the first and third planetary gear mechanisms P1, P3. Accordingly, the input shaft I is connected to the carrier shafts ca of the first and third planetary gear mechanisms P1, P3.

On the other hand, the connecting shaft S1 is configured such that it rotates integrally with a ring gear r of the first planetary gear mechanism P1, a rotor rt of the second electric motor MG2, a sun gear s of the second planetary gear mechanism P2, and a sun gear s of the third planetary gear mechanism P3.

Furthermore, a rotor rt of the first electric motor MG1 has such a structure as to rotate integrally with a sun gear s of the first planetary gear mechanism P1.

The drive unit M is provided with three friction engagement elements (i.e., the first and second clutches C1, C2, and the brake B1). The engagement or disengagement state of these three friction engagement elements C1, C2, B1 is determined according to an operation command from the control unit CPU.

The first clutch C1 determines the engagement or disengagement between the output shaft O and a ring gear r of the third planetary gear mechanism P3. In the engagement state, the ring gear r of the third planetary gear mechanism P3 rotates integrally with the output shaft O. However, in the engagement state, the first planetary gear mechanism P1 and the third planetary gear mechanism P3 form a four-element structure, and the rotation of the ring gear r of the third planetary gear mechanism P3 is transmitted to the output shaft O. In the disengagement state, the third planetary gear mechanism P3 does not affect the rotation of the output shaft O.

The brake B1 and the second clutch C2 determine the engagement or disengagement of a carrier shaft ca of the second planetary gear mechanism P2 and the casing C, as a ground, or the connecting shaft S1.

In the case where the brake B1 is engaged and the second clutch C2 is disengaged, the carrier shaft ca of the second planetary gear mechanism P2 is fixed, and the rotation of the connecting shaft S1 that is decelerated by the second planetary gear mechanism P2 is transmitted to the output shaft O.

On the other hand, in the case where the brake B1 is disengaged and the second clutch C2 is engaged, the carrier shaft ca of the second planetary gear mechanism P2 rotates together with the sun gear s and a ring gear r of the second planetary gear mechanism P2 and the connecting shaft S1. That is, a direct-coupling state is established in which the second planetary gear mechanism P2 is fixed, and the rotation of the ring gear r of the first planetary gear mechanism P1 is transmitted as it is to the output shaft O via the connecting shaft S1.

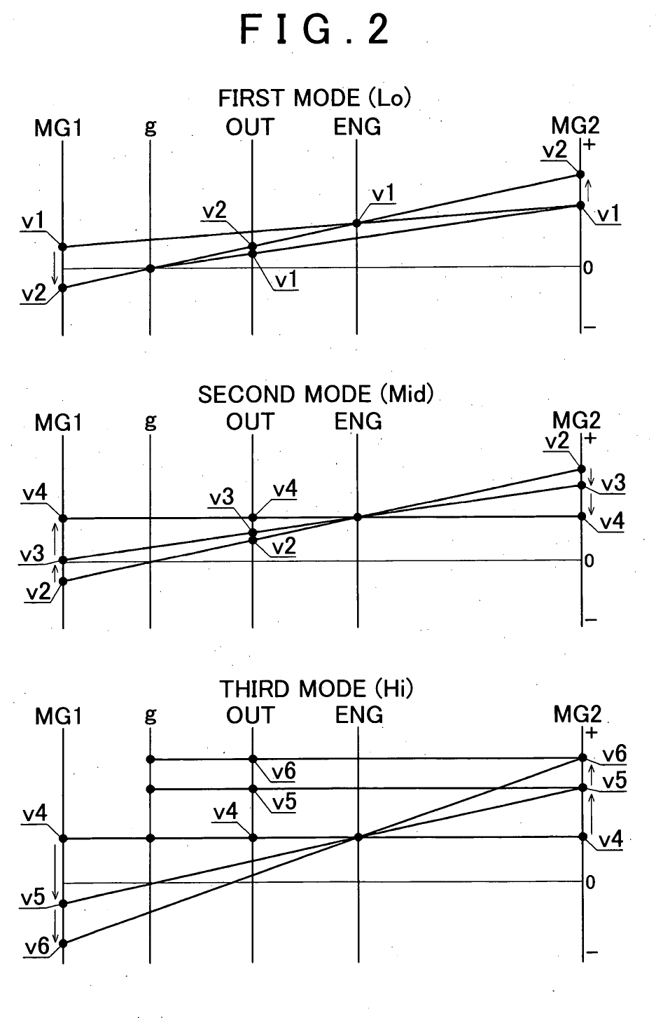

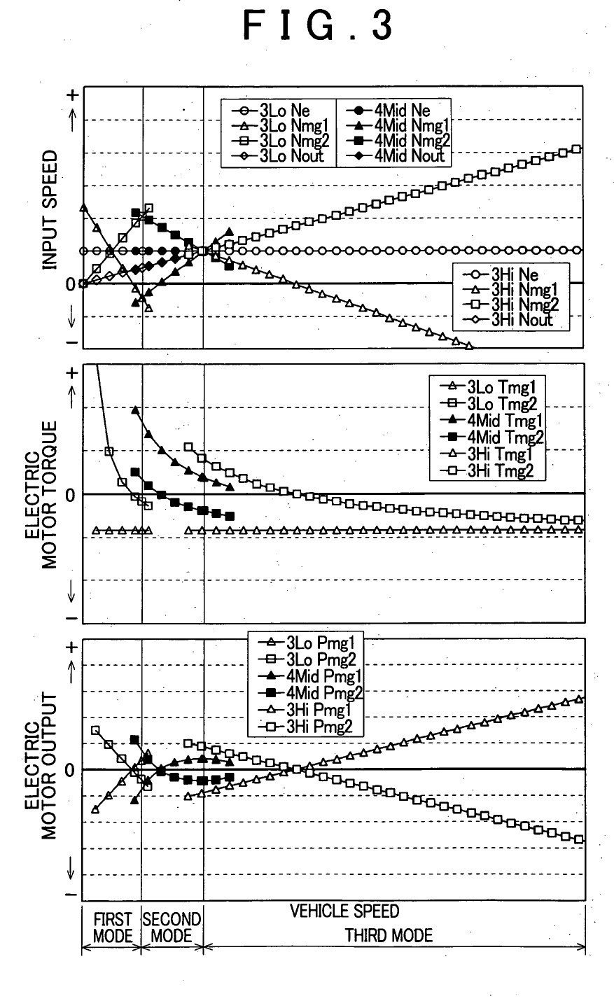

The configuration of the hybrid drive unit M has been described thus far. Hereinafter operation thereof, as well as modes of operation, will be described with reference to a velocity diagram shown in FIG. 2, and the input speed, electric motor torque, and electric motor output shown in FIG. 3.

The hybrid drive unit M as disclosed has three operation modes, i.e., a first mode, a second mode, and a third mode. The hybrid drive unit M is in a first power transmission state in the first mode, a second power transmission state in the second mode, and a third power transmission state in the third mode.

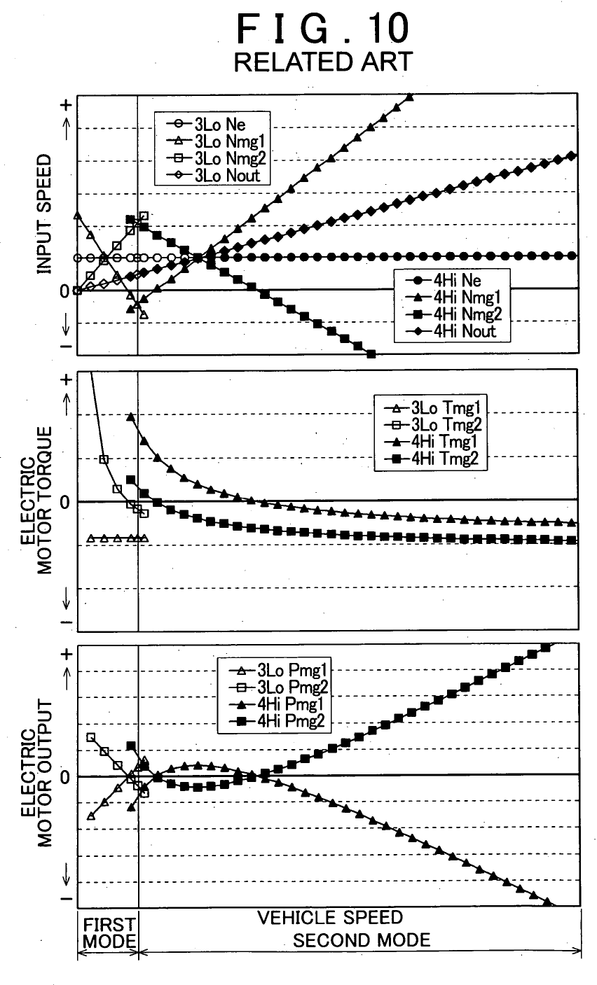

Note that the first mode corresponds to a low-speed range, and is denoted by “Lo” in FIGS. 2 and 3 (which should be compared to FIG. 10 of the related art). The second mode corresponds to a middle-speed range, and is denoted by “Mid” in FIGS. 2 and 3. The third mode corresponds to a high-speed range, and is denoted by “Hi” in FIGS. 2 and 3. In comparison with the above-described invention disclosed in Japanese Patent No. 3220115, the middle-speed range in the structure presently disclosed corresponds to a high-speed range of Japanese Patent No. 3220115. Accordingly, it can be said in an over simplification, that the invention has a structure in which an even higher speed range is added to a related art structure as described in Japanese Patent No. 3220115.

The engagement (ON) or disengagement (OFF) of the friction engagement elements C1, C2, B1 in each mode is performed as shown in the following Table 1.

| Mode | First mode | Second mode | Third mode |
|---|---|---|---|
| First clutch C1 | OFF | ON | OFF |
| Brake B1 | ON | OFF | OFF |
| Second clutch C2 | OFF | OFF | ON |

The power transmission state in each mode is as follows.

In the first mode (which assumes the first power transmission state), the first clutch C1 is maintained in a disengagement state, the brake B1 in an engagement state, and the second clutch C2 in a disengagement state.

As the first clutch C1 is maintained in the disengagement state in this mode, transmission from the input shaft I to the output shaft O is determined by the first and second planetary gear mechanisms P1, P2. More specifically, the engine rotation transmitted to the intermediate shaft M1 via the damper D is extracted as the rotation of the ring gear r in the planetary gear mechanism P1. Then, the rotation is transmitted to the sun gear s of the second planetary gear mechanism P2 via the connecting shaft S1, is decelerated by the second planetary gear mechanism P2, and is extracted from the output shaft O. At this time, in the first planetary gear mechanism P1, the rotor rt of the first electric motor MG1 rotates integrally with the sun gear s of the first planetary gear mechanism P1, whereby the first electric motor MG1 receives a reaction force of the driving force of the engine. On the other hand, the second electric motor MG2 assists the output.

Accordingly, this transmission state corresponds to the above-described power transmission state of the three-element structure, in which the rotational speed that can be extracted from the first planetary gear mechanism P1 is decelerated by the second planetary gear mechanism P2, and further transmitted to the output shaft O. Therefore, in FIG. 2, this transmission state is described as the first mode (Lo).

Further, as for the friction engagement element, the friction engagement element (the brake B1) that achieves the first power transmission state corresponds to a first friction engagement element.

Next, with reference to the velocity diagram shown in FIG. 2, the states of respective elements in this mode will be described. The velocity diagram shows on straight lines the relationship of the rotational speeds of the respective rotating elements of the planetary gear unit.

The vertical lines of the velocity diagram show, by height positions thereof, the rotational speeds of respective rotating elements. The respective rotating elements include, from the left side of the figure, a rotating element that rotates integrally with the first electric motor MG1 (denoted as MG1 in the figure), a rotating element that may be fixed to the ground via the brake B1 (denoted as g in the figure), the output shaft O (denoted as OUT in the figure), the intermediate shaft M1 (denoted by ENG in the figure), and the connecting shaft S1 (denoted as MG2 in the figure). As the position in the figure shifts to the upper side, the rotational speed becomes higher, and below the horizontal axis, the rotational speed assumes a negative value. Further, the velocity diagram shows, in the horizontal axis direction, a relative relationship of the gear ratios of the respective rotating elements.

In the first mode, as shown in the upper diagram, regarding the first planetary gear mechanism P1, the speed of the connecting shaft S1 is determined, as the speed obtained at MG2, by the velocity line that connects MG1, ENG, MG2. Furthermore, regarding the second planetary gear mechanism P2, the speed of the output shaft O is determined, as the speed obtained at OUT, by the velocity line that connects MG2, OUT, and g. Accordingly, MG1, ENG, MG2 at a vehicle speed v1 are as shown in the diagram.

From this state, as the vehicle speed increases, the operation is performed such that the speed on an MG1 side is lowered and the speed on an MG2 side is raised, as shown by arrows. This state is shown as v2 in the diagram. It can be seen that the speed v2 obtained at OUT is raised with respect to v1.

FIG. 3 shows the relationship of the input speed, electric motor torque, and electric motor output in the hybrid drive unit M. As the position in the figure shifts to the upper side, the input speed, electric motor torque, and electric motor output become higher, and in the region below the horizontal axis, they assume negative values.

In the figure, two fine vertical lines are illustrated to the right side of the left-end vertical line. These two lines correspond to the speed at the switching between the first and second modes, and the speed at the switching between the second and third modes, respectively.

Further, marks in FIG. 3 are shown such that the description related to the first mode is denoted by “3lo”, the description related to the second mode is denoted by “4Mid”, and the description related to the third mode is denoted by “3Hi”. The intermediate shaft M1, the first electric motor MG1, the second electric motor MG2, and the output shaft O are shown by marks identical to those shown in FIG. 10.

In the first mode that covers the low-speed range, the rotational speed of the input shaft, to which driving force is transmitted from the engine E, is maintained at a constant speed, while the rotational speed of the second electric motor MG2 increases in accordance with an increase in vehicle speed, and the rotational speed of the first electric motor MG1 decreases. As can be seen from the bottom graph in FIG. 3, the second electric motor MG2 mainly works as a motor, and the first electric motor MG1 mainly works as a generator. It can be seen that, in the first mode, the absolute values of the outputs of respective electric motors are within a limited range.

In the second mode (which assumes the second power transmission state), the first clutch C1 is maintained in an engagement state, the brake B1 in a disengagement state, and the second clutch C2 in a disengagement state.

When the first clutch C1 is engaged, the rotational speed of the ring gear r of the third planetary gear mechanism P3 is the same as that of the output shaft O. Shock can be eliminated by engaging or disengaging friction engagement elements in a state where the same speed condition is satisfied.

In this mode, the first clutch C1 is maintained in the engagement state, and the brake B1 in the disengagement state. Therefore, the transmission from the input shaft I to the output shaft O is determined by the first planetary gear mechanism P1 and the third planetary gear mechanism P3. More specifically, the engine rotation transmitted to the intermediate shaft M1 via the damper D is subject to driving force distribution determined by gear ratios of four rotating elements of the first planetary gear mechanism P1 and the third planetary mechanism P3, which constitute the four-element structure. Then, the distributed driving force is transmitted to the ring gear r of the third planetary gear mechanism P3, and transmitted to the output shaft O.

At this time, in the first planetary gear mechanism P1, the rotor rt of the second electric motor MG2 rotates integrally with the ring gear r of the first planetary gear mechanism P1, whereby the second electric motor MG2 mainly works to receive reaction force.

Accordingly, this transmission state corresponds to the above-described power transmission state of the four-element structure, in which the output that can be extracted through the first planetary gear mechanism P1 and the third planetary gear mechanism P3 is transmitted to the output shaft O as it is. Therefore, in FIG. 2, this transmission state is described as the second mode (Mid).

Further, as for the friction engagement element, the friction engagement element (the clutch C1) that achieves the second power transmission state corresponds to a second friction engagement element.

Next, with reference to the velocity diagram shown in FIG. 2, the states of respective elements in this mode will be described. The operation in the second mode is shown in the middle diagram of FIG. 2, and explained with velocity lines that connect the speeds shown by v2 to v4.

In the second mode, as shown in the middle diagram, regarding the first and third planetary gear mechanisms P1, P3, the speed of the output shaft O is determined, as the speed obtained at OUT, by the velocity line shown by v2 that connects MG1, OUT, ENG, and MG2.

From this state, the operation is performed such that the speed on an MG1 side is raised and the speed on an MG2 side is lowered as the vehicle speed increases, as shown by arrows, with the speed at ENG as a fulcrum (shift from v2 to v3 and v4). As a result, an operation state (shown by v4) is finally achieved in which the speeds of all the elements are the same.

Incidentally, as shown in FIG. 3, the input speed, the electric motor torque and the electric motor output are variable.

Also in the second mode that covers the middle-speed range, the rotational speed of the input shaft, to which driving force is transmitted from the engine E, is maintained at a constant speed, while the rotational speed of the second electric motor MG2 decreases in accordance with an increase in vehicle speed, and the rotational speed of the first electric motor MG1 increases. As can be seen from the bottom graph in FIG. 3, the second electric motor MG2 that has been working as a motor shifts to work as a generator, while the first electric motor MG1 that has been working as a generator shifts to work as a motor.

Also in the second mode, the absolute values of the outputs of respective electric motors are within a limited range.

In the third mode (which assumes the third power transmission state), the first clutch C1 and the brake B1 are maintained in a disengagement state, and the second clutch C2 is maintained in an engagement state. When the second clutch C2 is engaged, the rotational speed of the connecting shaft S1 is the same as that of the output shaft O. In this state, shock can be eliminated by engaging or disengaging friction engagement elements.

In this mode, the second clutch C2 is maintained in the engagement state, and other friction engagement elements C1, B1 are maintained in the disengagement state, so that the transmission from the input shaft I to the output shaft O is determined by the first planetary gear mechanism P1 and the second planetary gear mechanism P2. Because the second clutch C2 is engaged, the sun gear s of the second planetary gear mechanism P2 rotates together with the carrier shaft ca, whereby the connecting shaft S1 and the output shaft O creates a direct-coupling state. As a result, the driving force from the engine transmitted to the intermediate shaft M1 via the damper D is subject to shifting determined by the first planetary gear mechanism P1, and transmitted to the ring gear r of the first planetary gear mechanism P1, and then transmitted to the output shaft O as it is.

Also at this time, in the first planetary gear mechanism P1, the rotor rt of the first electric motor MG1 rotates together with the sun gear s of the first planetary gear mechanism P1, whereby the first electric motor MG1 works to receive a reaction force of the driving force from the engine.

Accordingly, this transmission state corresponds to the above-described power transmission state of the three-element structure, in which the output that can be extracted through the first planetary gear mechanism is transmitted to the output shaft O as it is. Therefore, in FIG. 2, this transmission state is described as the third mode (Hi).

Further, as for the friction engagement element, the friction engagement element (the clutch C2) that achieves the third power transmission state corresponds to a third friction engagement element.

Next, with reference to the velocity diagram shown in FIG. 2, the states of respective elements in this mode will be described. The operation in the third mode is shown in the lower diagram of FIG. 2, and explained with velocity lines that connect the speeds shown by v4 to v6.

In the third mode, as shown in the lower diagram, regarding the first planetary gear mechanism P1, the speed obtained by the connecting shaft S1 is determined by velocity lines shown by v4, v5, v6 that connect MG1, ENG, and MG2. In addition, the rotational speed of the output shaft O is determined by velocity lines shown by v4, v5, v6 that connect MG2, ENG, and OUT.

From this state, as the vehicle speed increases, the operation is performed such that an MG1 side is lowered and an MG2 side is raised as shown by arrows, with the speed at ENG being used as a fulcrum (shift from v4 to v5 and v6). Thus, an operation state is achieved in which the rotation of the connecting shaft S1 is output as it is.

Incidentally, as shown in FIG. 3, the input speed, the electric motor torque and the electric motor output are variable.

Also in the third mode that covers the high-speed range, the rotational speed of the input shaft, to which driving force is transmitted from the engine E, is maintained at a constant speed, while the rotational speed of the second electric motor MG2 increases in accordance with an increase in vehicle speed, and the rotational speed of the first electric motor MG1 decreases. It can be seen that, at this point, the second electric motor MG2 that has been working as a motor shifts to work as a generator, while the first electric motor MG1 that has been working as a generator shifts to work as a motor.

As shown in the bottom graph in FIG. 3, also in the third mode, the absolute values of the outputs of respective electric motors are within a limited range.

As can be understood from the above description, in this case, the first planetary gear mechanism P1 corresponds to a planetary gear device that works as a split device for distributing the driving force from the engine between the first and second electric motors MG1, MG2. The second planetary gear mechanism P2 corresponds to a planetary gear device that works as a speed reduction device in a state where the brake B1 is engaged.

Further, the brake B1, the first clutch C1, and the second clutch C2 constitute a switching mechanism.

Furthermore, in the configuration, the ring gear r of the second planetary gear mechanism P2 is provided so as to be rotatable integrally with the output shaft O. The first clutch C1 is configured to be engageable/disengageable between the output shaft O and the ring gear r of the third planetary gear mechanism P3, while the second clutch C2 is configured to be engageable/disengageable between the carrier shaft ca and the sun gear s of the second planetary gear mechanism P2. As a result, the output to the output shaft O is selected by selecting the engagement with the first clutch C1 or the second clutch C2. Accordingly, the second and third planetary gear mechanisms P2, P3, and the first and second clutches C1, C2 work as an output mechanism for selected output.

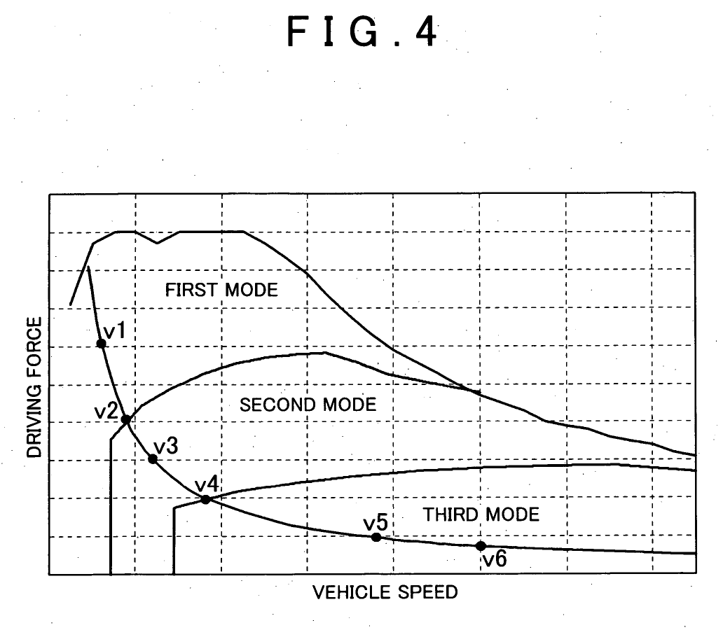

FIG. 4 shows driving forces obtained in respective modes when the hybrid drive unit M according to the disclosure is used. In the figure, the horizontal axis represents the vehicle speed, and the vertical axis represents the driving force.

In FIG. 4, driving forces required for vehicle running are indicated by lines that are monotone decreasing in accordance with an increase in vehicle speed. Further, on these lines, the speeds specified as v1, v2, v3, v4, v5, v6 in the velocity diagram in FIG. 2 are shown.

FIG. 4 shows ranges respectively covered by the first, second and third modes. It can be seen that, by the use of the hybrid drive unit M according to the previous disclosure discussion of an embodiment, good shifting can be performed with ease during vehicle running, while the engine is working at the most efficient rotational speed.

Additional embodiments will be described below.

As described earlier, the hybrid drive unit according to the disclosure is provided with two electric motors. The power transmission system of the hybrid drive unit is configured to include three planetary gear mechanisms P1, P2, P3 arranged between the input shaft I and the output shaft O, and three friction engagement elements C1, C2, B1.

As its operation mode (power transmission state), the first mode (first power transmission state), the second mode (second power transmission state), and the third mode (third power transmission state) can be realized. In the first mode, the rotational speed of the three-element structure for the low-speed range is further decelerated and output. In the second mode, the rotational speed obtained by the four-element structure for the middle-speed range is output as it is. In the third mode, the rotational speed obtained by the three-element structure for the high-speed range is output as it is.

Three other embodiments to be described below respectively maintain the above-described technological structure. As friction engagement elements, two clutches (a first clutch C1 and a second clutch C2) and a brake B1 are provided, similar to the above-described embodiment. The switching between engagement and disengagement of these friction engagement elements is performed in a similar manner to that explained in Table 1, and first to third modes can be realized. Further, a velocity diagram corresponding to each mode is similar to that in the above-described embodiment. Names of planetary gear mechanisms are referred to as first, second, and third planetary gear mechanisms P1, P2, P3, in the order provided from an input shaft I side to an output shaft O side.

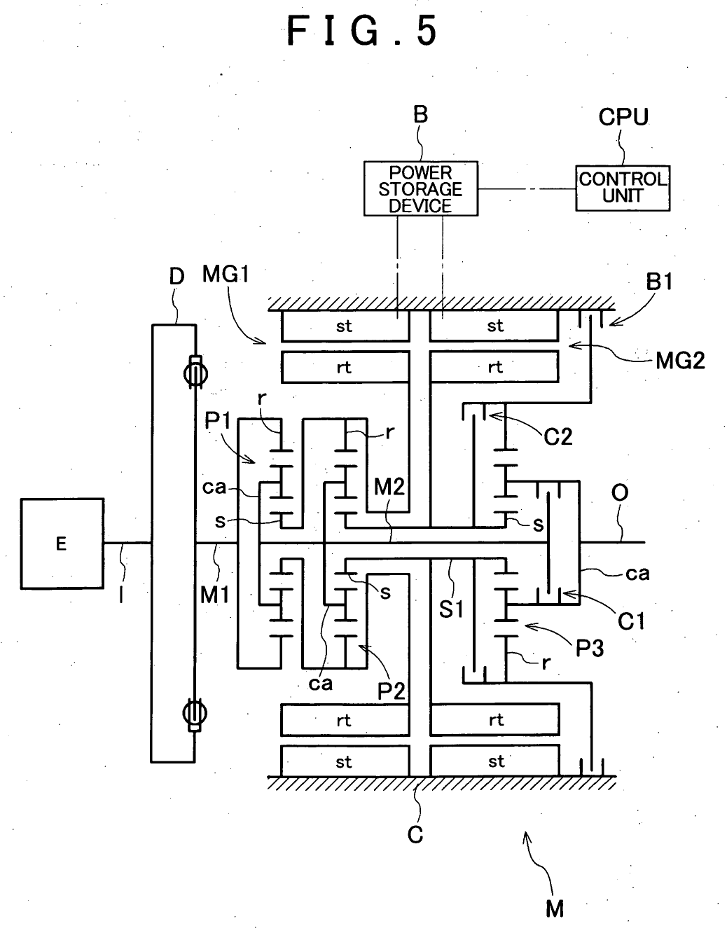

In FIGS. 5, 6 and 7, to be described below, elements corresponding to those of the hybrid drive unit shown in FIG. 1 are denoted by like reference numerals. Hereinafter, an arrangement configuration of each of the other embodiments will be described.

FIG. 5 shows an exemplary configuration, of a second embodiment, in which an input shaft I is provided on the left side and an output shaft O is provided on the right side, similar to the configuration shown in FIG. 1. Rotation of the input shaft I is transmitted to be received by a first intermediate shaft M1 via a damper D. The first intermediate shaft M1 is configured to rotate integrally with a ring rear r of a first planetary gear mechanism P1. On the other hand, a sun gear s of the first planetary gear mechanism P1 rotates integrally with a ring gear r of a second planetary gear mechanism P2, and is directly connected to a rotor rt of a first electric motor MG1.

Carrier shafts ca of the first and second planetary gear mechanisms P1, P2 are configured to rotate integrally with a second intermediate shaft M2. The second intermediate shaft M2 is configured such that, at a downstream side thereof, it is engageable/disengageable with the output shaft O via a first clutch C1.

On the other hand, a sun gear s of the second planetary gear mechanism P2 is adapted to rotate integrally with a connecting shaft S1. The connecting shaft S1 rotates integrally with a rotor rt of a second electric motor MG2. Further, a second clutch C2 is provided for the connecting shaft S1 so that the connecting shaft S1 is rotatable integrally with a ring gear r of a third planetary gear mechanism P3.

The third planetary gear mechanism P3 is configured such that the ring gear r is engageable/disengageable with the ground (casing) via a brake B1, a carrier shaft ca is integral with the output shaft O, and a sun gear s rotates integrally with the connecting shaft S1.

This exemplary configuration is different from the configuration shown in Japanese Patent No. 3220115 in that the second clutch C2 is provided between the connecting shaft S1 and the ring gear r of the third planetary gear mechanism P3.

Accordingly, in a state where the second clutch C2 is disengaged, the first and second modes explained earlier in relation to the related art can be realized. Further, in the third mode, the connecting shaft S1 can be directly coupled to the output shaft O via the third planetary gear mechanism P3, by engaging the second clutch C2 while the first clutch C1 and the brake B1 are disengaged. Thus, power transmission of the three-element structure in a direct-coupling state can be realized in which the first and second planetary gear mechanisms P1, P2 are integrated.

In this exemplary configuration, the first and second planetary gear mechanisms P1, P2 correspond to a planetary gear device that works as a split device, and the third planetary gear mechanism P3 corresponds to a planetary gear device that works as a speed reduction device in a state where the brake B1 is engaged. Further, the brake B1, the first clutch C1, and the second clutch C2 constitute the switching mechanism.

In addition, in this configuration, the carrier shaft ca of the third planetary gear mechanism P3 is provided so as to be rotatable integrally with the output shaft O. Further, the first clutch C1 is configured to be engageable and disengageable between the second intermediate shaft M2 and the output shaft O, and the second clutch C2 is configured to be engageable and disengageable between the ring gear r and the sun gear s of the third planetary gear mechanism P3. As a result, output to the output shaft O is selected by the engagement selection between the first and second clutches C1, C2. Accordingly, the third planetary gear mechanism P3 and the first and second clutches C1, C2 form an output mechanism for selective output.

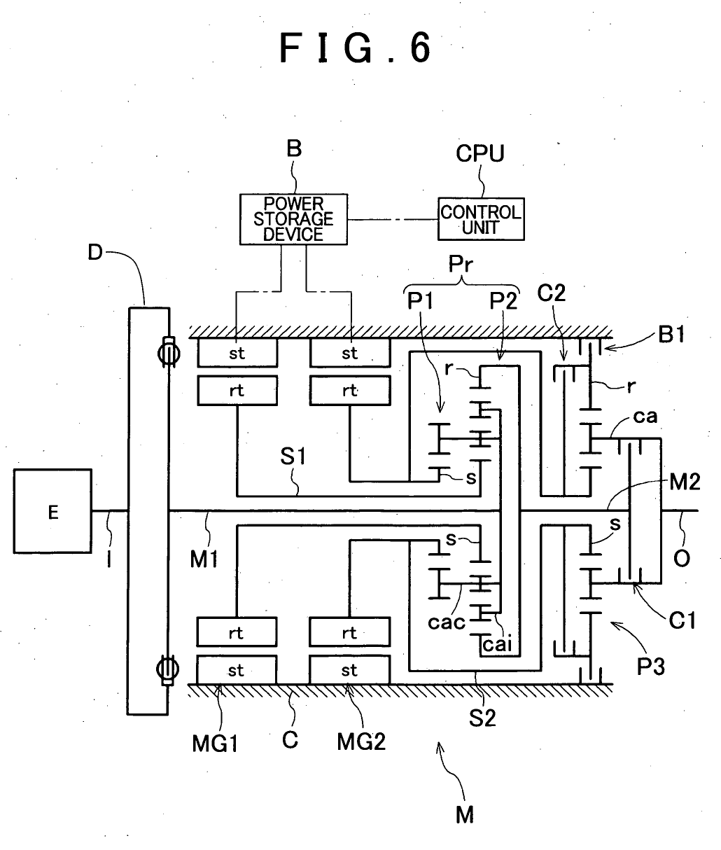

FIG. 6 shows an exemplary configuration, of a third embodiment, in which an input shaft I is provided on the left side and an output shaft O is provided on the right side, similar to the configuration shown in FIG. 1. In this exemplary configuration, first and second planetary gear mechanisms P1, P2 constitute a planetary gear device Pr of a so-called Ravigneaux type. More specifically, the second planetary gear mechanism P2 is of a double pinion type, and a carrier shaft of pinions located in an inner diameter side thereof is a common carrier shaft (referred to as a common carrier shaft cac in the description below) for the first and second planetary gear mechanisms P1, P2. Although the second planetary gear mechanism P2 is of the double pinion type as shown in FIG. 6, the carrier shafts ca of the pinions of the planetary gear mechanism P2 rotate at the same speed.

As shown in FIG. 6, in this exemplary configuration, rotation of the input shaft I is transmitted to be received by a first intermediate shaft M1 via a damper D. The first intermediate shaft M1 is adapted to rotate integrally with the common carrier shaft cac provided for the first and second planetary gear mechanisms P1, P2. In the second planetary gear mechanism P2, the rotation is transmitted also to a carrier shaft cai located on an outer diameter side of the double pinion.

A rotor rt of the first electric motor MG1 is configured to be rotatable integrally with a sun gear s of the second planetary gear mechanism P2 via a first connecting shaft S1. On the other hand, a rotor of the second electric motor MG2 is configured to be rotatable integrally with a sun gear s of the first planetary gear mechanism P1, and rotation thereof is transmitted to a sun gear s of the third planetary gear mechanism P3 on a downstream side of power transmission, via a second connecting shaft S2. At the same time, the rotation is transmitted to a ring gear r of the third planetary gear mechanism P3 through engagement of a second clutch C2. In this manner, the rotation of the second connecting shaft S2 is transmitted to the sun gear s of the third planetary gear mechanism P3, and a carrier shaft ca of the third planetary gear mechanism P3 rotates integrally with the output shaft O.

On the other hand, the ring gear r of the third planetary gear mechanism P3 is configured such that driving force transmitted to the sun gear s can be transmitted to the output shaft O via a carrier shaft ca of the third planetary gear mechanism P3, depending on engagement/disengagement of a brake B1 and the second clutch C2.

More specifically, in a state where the brake B1 is engaged and a clutch C1 and the clutch C2 are both disengaged, the ring gear r is fixed, and the rotation of the second connecting shaft S2 is decelerated and then transmitted to the output shaft O. At this time, a planetary gear transmission state is achieved by the sun gear s of the second planetary gear mechanism P2, pinions provided for the common carrier shaft cac, and the sun gear s of the first planetary gear mechanism P1.

On the other hand, in a state where the second clutch C2 is engaged and the brake B1 and the first clutch C1 are disengaged, the third planetary gear mechanism P3 is fixed. Therefore, rotation of the second connecting shaft S2 is transmitted to the output shaft O as it is.

Then, in a state where the first clutch C1 is engaged and the brake B1 and the second clutch C2 are disengaged, the first to third planetary gear mechanisms P1, P2, P3 constitute the above-described four-element structure. Thus, the input to the first intermediate shaft M1 is transmitted to the output shaft O through the four-element structure.

In the first mode, the output (i.e., rotation of the second connecting shaft S2) obtained by the three-element structure constituted by the first and second planetary gear mechanisms P1, P2 can be decelerated by the third planetary gear mechanism P3, and then output to the output shaft O as rotation of the carrier shaft ca of the third planetary gear mechanism P3.

In the second mode, only the first clutch C1 is engaged. Accordingly, the transmission to the output shaft O assumes the power transmission state of the four-element structure by the first to third planetary gear mechanisms P1, P2, P3.

In the third mode, only the second clutch C2 is engaged, and consequently, the third planetary gear mechanism P3 is fixed. Accordingly, the power transmission state of the three-element structure determined by the first and second planetary gear mechanisms P1, P2 can be achieved in which the output side is in a direct-coupling state.

As is apparent from the above description, in this exemplary configuration, the first and second planetary gear mechanisms P1, P2 correspond to a planetary gear device that works as a split device, and the third planetary gear mechanism P3 corresponds to a planetary gear device that works as a speed reduction device in a state where the brake B1 is engaged. In the present embodiment, the first and second planetary gear mechanisms P1, P2 working as the split device, and the planetary gear mechanism P3 working as the speed reduction device forms an output mechanism. Further, the brake B1, the first clutch C1, and the second clutch C2 constitute the switching mechanism.

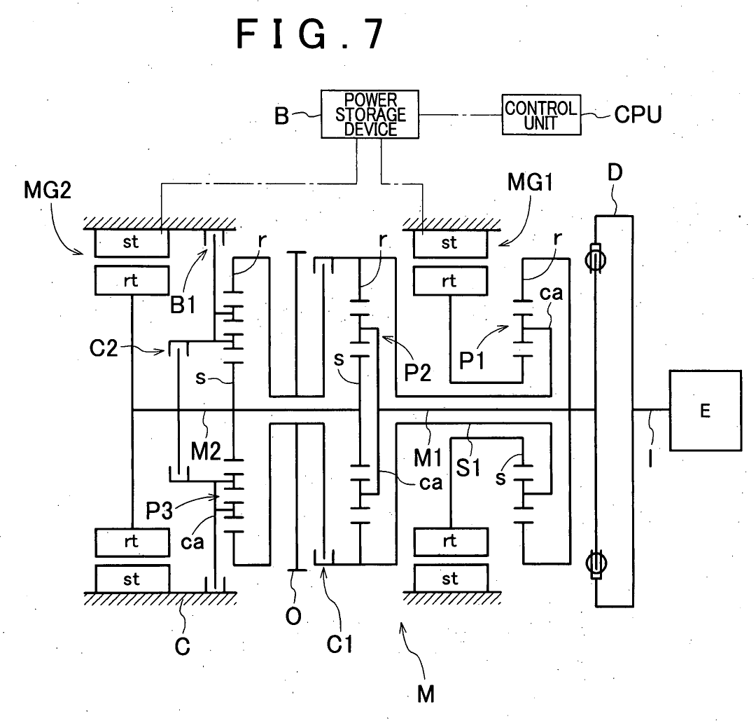

FIG. 7 shows an exemplary configuration, of a fourth embodiment, in which an input shaft I is provided on the right side and an output shaft O is provided on the left side to the center, contrary to the configuration shown in FIG. 1. Rotation of the input shaft I is transmitted to be received by a first intermediate shaft M1 via a damper D. The first intermediate shaft M1 is configured to rotate integrally with a ring gear r of a first planetary gear mechanism P1 and a carrier shaft ca of a second planetary gear mechanism P2. On the other hand, a sun gear s of the first planetary gear mechanism P1 is connected to a rotor rt of a first electric motor MG1. A ring gear r of the second planetary gear mechanism P2 is provided on a connecting shaft S1 that rotates integrally with a carrier shaft ca of the first planetary gear mechanism P1, and a carrier shaft ca of the second planetary gear mechanism P2 rotates integrally with the first intermediate shaft M1. On the other hand, a sun gear s of the second planetary gear mechanism P2 is provided on a second intermediate shaft M2 that rotates integrally with a rotor rt of a second electric motor MG2 on a downstream side of power transmission. The second intermediate shaft M2 is provided with a sun gear s of a third planetary gear mechanism P3, and is rotatable integrally with a carrier shaft ca of the third planetary gear mechanism P3 by means of a second clutch C2.

A ring gear r of the third planetary gear mechanism P3 rotates integrally with the output shaft O. Further, the carrier shaft ca of the third planetary gear mechanism P3 is rotatable integrally with the second intermediate shaft M2 via the second clutch C2, and can be fixed to the ground via a brake B1.

In the first mode, the rotation is transmitted to the second intermediate shaft M2 in the three-element structure via the first and second planetary gear mechanisms P1, P2, and the output is decelerated by the third planetary gear mechanism P3 and then output to the output shaft O.

In the second mode, only the first clutch C1 is engaged. Accordingly, the output shaft O rotates integrally with the connecting shaft S1. In this state, the output of the output shaft O assumes the power transmission state of the four-element structure by the first and second planetary gear mechanisms P1, P2.

In the third mode, only the second clutch C2 is engaged. Accordingly, the third planetary gear mechanism P3 is fixed, and the second intermediate shaft M2 and the output shaft O rotate at the same speed. Thus, in the power transmission state of the three-element structure where the first and second planetary gear mechanisms P1, P2 are integrated, a power transmission state can be obtained in which the output side is in a direct-coupling state.

As is apparent from the above description, in this exemplary configuration, the first and second planetary gear mechanisms P1, P2 correspond to a planetary gear device that works as a split device, and the third planetary gear mechanism P3 corresponds to a planetary gear device that works as a speed reduction device in a state where the brake B1 is engaged.

Further, the brake B1, the first clutch C1, and the second clutch C2 constitute the switching mechanism.

Also, in this configuration, the ring gear r of the third planetary gear mechanism P3 is provided so as to be rotatable integrally with the output shaft O. The first clutch C1 is engageable/disengageable between the connecting shaft S1 and the output shaft O, and the second clutch C2 is engageable/disengageable between the second intermediate shaft M2 and the carrier shaft ca of the third planetary gear mechanism P3. As a result, the output to the output shaft O is selected by the engagement selection between the first and second clutches C1, C2. Accordingly, the third planetary gear mechanism P3 and the first and second clutches C1, C2 form an output mechanism for selective output.

A hybrid drive unit including a planetary gear unit and two electric motors between an input shaft and an output shaft can be obtained. The configuration of the hybrid drive unit can achieve a continuously variable transmission without performing stepped speed change when changing gears by engaging or disengaging a plurality of friction engagement elements. Doing such prevents deterioration in energy recovery efficiency during regeneration, and does not cause deterioration in power transmission efficiency in a high-vehicle speed and low-driving force range (or a negative hybrid range).

What is claimed is:

1. A hybrid drive unit, comprising:
an input shaft for receiving driving force from an engine;
an output shaft for outputting the driving force to a wheel;
a first electric motor and a second electric motor;
a planetary gear unit;
a first friction engagement element that forms a first power transmission state between the input shaft and the output shaft;
a second friction engagement element that forms a second power transmission state between the input shaft and the output shaft; and
a third friction engagement element that forms a third power transmission state between the input shaft and the output shaft, wherein
in the first power transmission state, the input shaft is connected to a first rotating element of the planetary gear unit, the first electric motor is connected to a second rotating element of the planetary gear unit, and the output shaft and the second electric motor are connected to a third rotating element of the planetary gear unit;
in the second power transmission state, the input shaft, the output shaft, the first electric motor, and the second electric motor are independently connected to four rotating elements of the planetary gear unit; and
in the third power transmission state, the input shaft is connected to the first rotating element of the planetary gear unit, the first electric motor is connected to the second rotating element of the planetary gear unit, and the output shaft and the second electric motor are connected to the third rotating element of the planetary gear unit, and a speed reduction ratio is smaller than that in the first power transmission state.

2. The hybrid drive unit according to claim 1, wherein engagement and disengagement of two friction engagement elements of the first to third friction engagement elements are operatively associated with each other.

3. The hybrid drive unit according to claim 1, wherein on a condition that two members engaged by the friction engagement elements rotate at the same speed, the power transmission state is switched by switching of an engagement/disengagement state of the two friction engagement elements of the first to third friction engagement elements.

4. The hybrid drive unit according to claim 1, wherein the first friction engagement element is a brake that stops, in an engagement state, rotation of one rotating element of a planetary gear device working as a speed reduction device; and in the first power transmission state, only the first friction engagement element is engaged, and rotation of the third rotating element of the planetary gear unit is decelerated by the speed reduction device and then transmitted to the output shaft.

5. The hybrid drive unit according to claim 1, wherein the second friction engagement element is a clutch that directly connects, in an engagement state, the output shaft with one rotating element of the planetary gear unit; and, in the second power transmission state, only the second friction engagement element is engaged, and the output shaft is directly connected to the one rotating element of the four rotating elements of the planetary gear unit.

6. The hybrid drive unit according to claim 1, wherein the third friction engagement element is a clutch that directly connects, in an engagement state, two rotating elements of one planetary gear mechanism; and in the third power transmission state, only the third friction engagement element is engaged to fix the planetary gear mechanism, whereby rotation of the third rotating element of the planetary gear unit is transmitted to the output shaft as it is.

7. The hybrid drive unit according to claim 1, wherein the first electric motor, the second electric motor, and a switching mechanism having the first to third friction engagement elements are coaxially provided; and the first electric motor, the second electric motor, and the switching mechanism are arranged in this order from a side of the engine to a side of the output shaft.

8. The hybrid drive unit according to claim 1, wherein the planetary gear unit includes three planetary gear mechanisms; and in the third power transmission state, one planetary gear mechanism is fixed by engagement of the third friction engagement element, and the output shaft and the third rotating element of the planetary gear unit rotate at the same speed.

9. The hybrid drive unit according to claim 1, wherein the second power transmission state is realized by providing a second planetary gear device, in addition to a first planetary gear device, as the planetary gear unit; the first planetary gear device including an input rotating element connected to the input shaft, an output rotating element connected to the output shaft, and a rotating element connected to the second electric motor, the second planetary gear device including a rotating element connected to the input rotating element of the first planetary gear device, a rotating element connected to the second electric motor, and a rotating element connected to the first electric motor.

10. A hybrid drive unit, comprising:
an input shaft for receiving driving force from an engine;
an output shaft for outputting the driving force to a wheel;
a first electric motor and a second electric motor; and
a planetary gear unit, wherein the hybrid drive unit has three operation modes comprising:
a first mode driven by a three-element structure in which the input shaft is connected to a first rotating element of the planetary gear unit, the first electric motor is connected to a second rotating element of the planetary gear unit, and the output shaft and the second electric motor are connected to a third rotating element of the planetary gear unit;
a second mode driven by a four-element structure in which the input shaft, the output shaft, the first electric motor, and the second electric motor are independently connected to four rotating elements of the planetary gear unit; and
a third mode driven by the three-element structure in which a speed reduction ratio is different from that in the first mode, and as the speed reduction ratio becomes small, switching is performed in the order from the first mode, the second mode, to the third mode.

11. The hybrid drive unit according to claim 10, wherein in the third mode, a rotational speed of the third rotating element obtained by the three-element structure is directly transmitted to the output shaft.

12. The hybrid drive unit according to claim 10, wherein the first electric motor, the second electric motor, and as the planetary gear unit, a planetary gear device working as a split device that distributes the driving force from the engine between the first electric motor and the second electric motor, and a planetary gear device working, in a power transmission state of the three-element structure, as a speed reduction device that reduces driving force output from the third rotating element, are coaxially provided; and the first electric motor, the split device, the second electric motor, and the speed reduction device are arranged in order from the side of the engine to the side of the output shaft.

13. The hybrid drive unit according to claim 10, wherein three friction engagement elements and the two planetary gear devices are provided as the planetary gear unit; the driving force from the engine is distributed between the first electric motor and the second electric motor; and an output mechanism for selectively outputting the distributed output to the output shaft is provided in a main body of the drive unit at a position farthest from the engine.
